(19) United States
(12) Patent Application Publication
(10) Pub. No.: US 2007/0140232 A1
(43) Pub. Date: Jun. 21, 2007

(54) Self-steering Clos switch

(76) Inventor: Mark Brian Carson, Belfast (GB)

Correspondence Address: THELEN REID BROWN RAYSMAN & STEINER LLP, P. O. BOX 640640, SAN JOSE, CA, 95164-0640, US

(21) Appl. No.: 11/303,231

(22) Filed: Dec. 16, 2005

(51) Int. Cl. H04Q 11/00; H04L 12/50

(52) U.S. Cl. 370/388; 370/375

(57) ABSTRACT

A self-steering switch includes an input stage, and output stage, and an arbitration stage. The input stage is configured to accumulate a surplus of switching cycles, allowing the arbitration stage to resolve traffic congestion without blockage. The arbitration stage includes a configuration memory, one or more arbitrators, and one or more buffers in which queuing of memory requests is conducted. Contention for memory access is resolved by the arbitrators on a fair basis, for example through a round-robin scheme.

### CROSS-REFERENCE TO RELATE APPLICATIONS

(Not applicable)

### BACKGROUND OF THE INVENTION

1. Field of the Invention

The invention relates to Clos switch architecture used for example in telecommunications systems, and more particularly, to a variant of the Clos switch, known as the Time-Space-Time Clos.

2. Description of the Related Art

A key feature of telecommunications systems based on the SONET/SDH standards is the ability to switch traffic arriving on one port of a system, so that it can be output on any other port of the system. In equipment operating at the edge of the network, this switching needs to be performed with fine granularity (1.5 or 2 Mbits/s). Devices that can operate at this level are referred to as VT or VC-12 switches.

Typical systems (SONET/SDH multiplexors) are required to interconnect many hundreds or thousands of these connections. For example, a MSPP (Multi-Service Provisioning Platform) product could require a 8064 port VT switch. The MSPP switch is a relatively small part. Commercial devices exist that can switch between over 21,000 ports (40 Gbit/s).

Two techniques are normally adopted for building very large VT switches. These are “square” and Clos designs. The same is also true of the higher capacity STS switches used in telecommunications systems, to which the present invention may be applicable.

Square switches operate by writing incoming data into a memory, from which it is read whenever it is needed to be written to an output port. Because the memory can only be accessed by one output port at a time, it is necessary to provide a separate copy of the memory for each physical output port. Thus doubling the size of a switch results in a four-times increase in the size of the switch memory. For the 40 Gbit/s switch described above, this equates to 6.8 Mbits of RAM, and for an 80 Gbit/s switch it requires 27.1 Mbits. Large memory requirements limit the size of switch that can be implemented in either FPGA or ASIC technology.

The second technique is the Clos switch, which utilizes an array of smaller switches, normally arranged in either 3 or 5 columns. The Clos switch requires much less memory, but is more complex to configure. Normally a computer algorithm is used to convert the switch map into a form that can be applied to a Clos switch.

Square switches are easy to configure, and have the ability to connect any input port to any output port, without restriction. A disadvantage of square switches is that their memory requirement grows according to a square law, making the construction of large square switches very expensive.

Clos switches have much smaller memory requirements, but they are complex to configure, and are subject to a problem called blocking. This occurs when a desired connection between input and output ports cannot be implemented, because other existing connections in the switch matrix ‘block’ the new connection.

One variant of the Clos switch is known as a “Time-Space-Time Clos.” In a conventional Time-Space-Time Clos switch, an algorithm is required to find time-slots during which a centre stage element is available to transfer data from one input port to one or more output ports. As the number of connections in a switch increases, it becomes more difficult to find suitable center stage timeslots. Eventually it may become necessary to rearrange other connections within the switch to make a new connection.

### BRIEF SUMMARY OF THE INVENTION

In order to address the above-mentioned limitations associated with the prior art, a Self-Steering Clos switch is disclosed which adds a queuing function between the input and output memories. Each time an input memory is read, the result is placed in a queue dedicated to that memory. Each of the output RAMs has an associated arbitrator that monitors all of the queues coming from the input RAMs. The arbitrator reads data from the input RAM queues using a suitable scheduling scheme, such as fair round-robin, transferring the data to the output RAMs.

Thus if a center stage timeslot is not available at the exact time the data is read from the input RAM, the data will be held in a center stage queue until the required output RAM becomes available. An external algorithm is no longer required to configure the Clos, as the traffic is steered through it using the internal logic.

The inventive system has similarities to packet switching, but still maintains the very low latency, and deterministic timing required by Sonet/SDH switches.

The invention in one aspect provides a technique for efficiently building switches, avoiding the very large amounts of memory that are normally associated with large switches, while allowing the switch to be programmed by software as if it were a conventional design.

The invention in this aspect is related to the Clos switch architecture, but allows the switch to be configured in the same way as a conventional square switch. Specifically, it is derived from a variant of the Clos switch, known as the Time-Space-Time Clos.

In a conventional Clos switch, the configuration of the switch determines when a byte of data is moved (scheduled) from one stage of the switch to the next. A switch in accordance with the invention is arranged similarly to a Clos switch, but in which data moving from one stage to the next is queued until the relevant resource in the next stage becomes available. The result is a “self-scheduling” or “self-steering” Clos.

By having a Clos structure, the memory requirements are greatly reduced. An 80 Gbit/s square switch would require 27.1 Mbits of traffic RAM. The equivalent 80 Gbit/s switch built using this architecture requires 1.5 Mbits of traffic RAM.

As the data moving through the switch is self-steered, only the input and output port identifiers need to be provided. The path which the data follows through the switch is determined by the switch logic itself. This means that the switch does not need the complex configuration normally associated with a Clos. Configuration of the inventive self-steering Clos can be made to appear identical to that of a conventional square switch.

One feature of the inventive self-steering Clos is a RAM requirement that grows linearly, as with a Time-Space-Time Clos, rather than according to a square law. Another feature is a switch which is configured in a similar manner as a conventional square switch. A single value representing the required input port is programmed into a location denoting the output port. In order to minimize the risk of blocked connections affecting normal traffic, the bandwidth provided between the input and output RAMs of the self-steering Clos is more than doubled. The delay through the switch can be set to be just over ⅓ of a Sonet/SDH row, which is the typical delay of a square switch, rather than the ⅔ of a row which would be typical of a conventional Time-Space-Time Clos.

### BRIEF DESCRIPTION OF THE SEVERAL VIEWS OF THE DRAWINGS

Many advantages of the present invention will be apparent to those skilled in the art with a reading of this specification in conjunction with the attached drawings, wherein like reference numerals are applied to like elements, and wherein:

FIG. 1 is a schematic drawing of a conventional square switch architecture;

FIG. 2 is graph showing the growth of memory requirements in accordance with a square law for a conventional square switch;

FIG. 3 is schematic diagram of a general conventional Clos-type switch;

FIG. 4 is a schematic diagram of a self-steering switch in accordance with the invention;

FIG. 5 is a graph showing memory requirement growth with the growth of data throughput of a self-steering in accordance with the invention, which is linear rather than according to a square law;

FIG. 6 is a schematic diagram illustrating the use of a conventional two-port RAM;

FIG. 7, is a schematic diagram illustrating the use of two memories which are identical to the RAM in FIG. 6 and configured to form a 2×2 port RAM

FIG. 8 is a schematic diagram showing the use of a dual-port memory;

FIG. 9 is a schematic diagram showing the use of two dual-port memory devices similar to the RAM of FIG. 8;

FIG. 10 is a schematic diagram showing a different representation of the memory devices of FIG. 9; and

FIG. 11 is a schematic diagram showing three dual-port memory devices arranged in accordance with the invention.

### DETAILED DESCRIPTION OF THE INVENTION

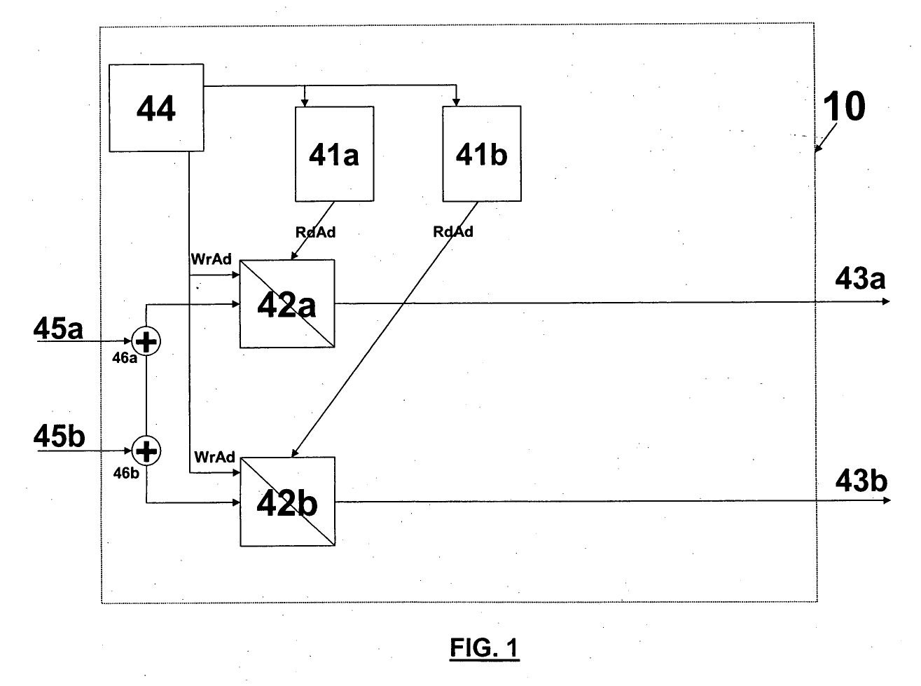

FIG. 1 is a schematic drawing of a conventional square switch architecture. For simplicity, switch 10 is shown as having two input ports 45a, 45b, and two output ports 43a, 43b, although typically many more input and output ports are used. Because switch 10 is a square switch, it is nonblocking, and information entering the switch from any port (45a, 45b) can be output at any port (43a, 43b) without restriction. Using time division multiplexing, a continuous stream of information arrives at the two inputs 45a, 45b in a repeating frame structure, each frame containing hundreds or thousands of channels. In a typical model in a telecommunication system operating on an eight kilohertz cycle, a frame of data is received every 125 microseconds.

The information stream arriving at ports 45a, 45b is written into the two memories, 42a, 42b, respectively, in basically linear ascending order. At the start of every switching period (typically 125 microseconds or some fraction thereof), application zero (first application) begins in memory. Each sample at a port 45 is written in a memory 42, until all the samples have been written. Then, at the beginning of the next period, writing begins again at the first location (memory 42), and the cycle is repeated.

The diagonal line in each of memory blocks 42a, 42b indicates that the memory block actually consists of two memories, a write memory accessed through a write address (WrAd) and a read memory accessed through a read address (RdAd). Information from each of the two ports 45a, 45b is written into both memories 42a, 42b, as enabled by combining nodes 46a and 46b, in effect widening the size of the required memory, which is typically a RAM (Random Access Memory) or the like. Writing data into both memories 42a and 42b makes the data accessible to both output port 43a connected to memory 42a, and output port 43b connected to memory 42b. Control and timing of the read and write operations is performed by controller 44. Memories 41a and 41b contain the switch configuration, and provide the read addresses (RdAd) for memories 41a and 42b. These memories are programmed by the user to define the switching operation to be performed.

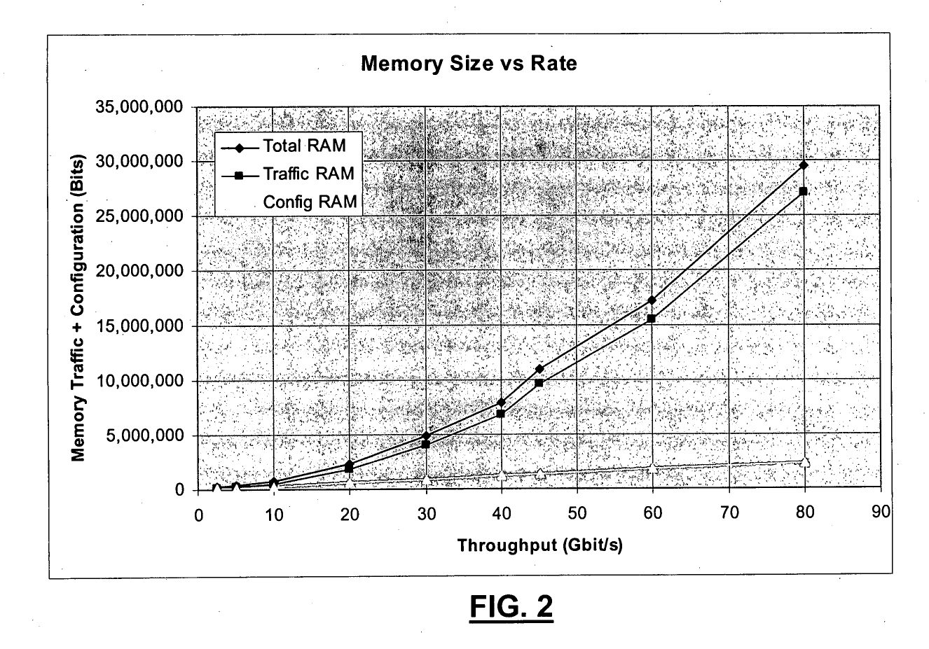

Square switch 10, having two input ports 45a, 45b and two output ports 43a, 43b, requires a total of four memories—two write memories and two read memories. In general, the size of the traffic memory required grows with the square of the number of input/output ports of the switch, as FIG. 2 illustrates. At 80 Gbits traffic width, a typical size in the industry today, 27 Mbits of memory is required.

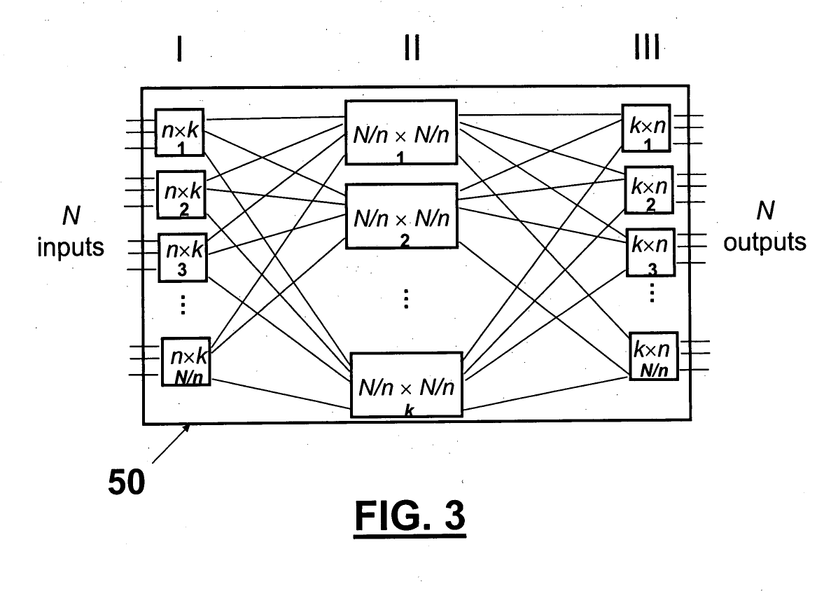

One approach to reducing the memory requirements of large switches is to construct what is generally known as a Clos type switch. This approach effectively breaks up the large switch into a multiplicity of smaller switches arranged in separate stages. The drawback of this approach is that it introduces significant complexity. The individual switches and stages have to be properly configured and connected to one another, and each individually set up. Moreover, a Clos type switch maybe be subject to blocking, whereby not all output ports can have access to information from all input ports. A rearrangeably non-blocking Clos switch avoids this, but at the expense of increasing the size of the center stage. A general example of a Clos type switch is depicted in FIG. 3 and is denoted at 50. It is shown as having N inputs, N outputs, and three stages I, II, and III. Stages I and III consist of a plurality of n×k and k×n switches, while stage II consist of a plurality (k) of smaller N/n×N/n memories. Clos type switches are well-known in the art, and further description thereof is unnecessary for an understanding of the invention.

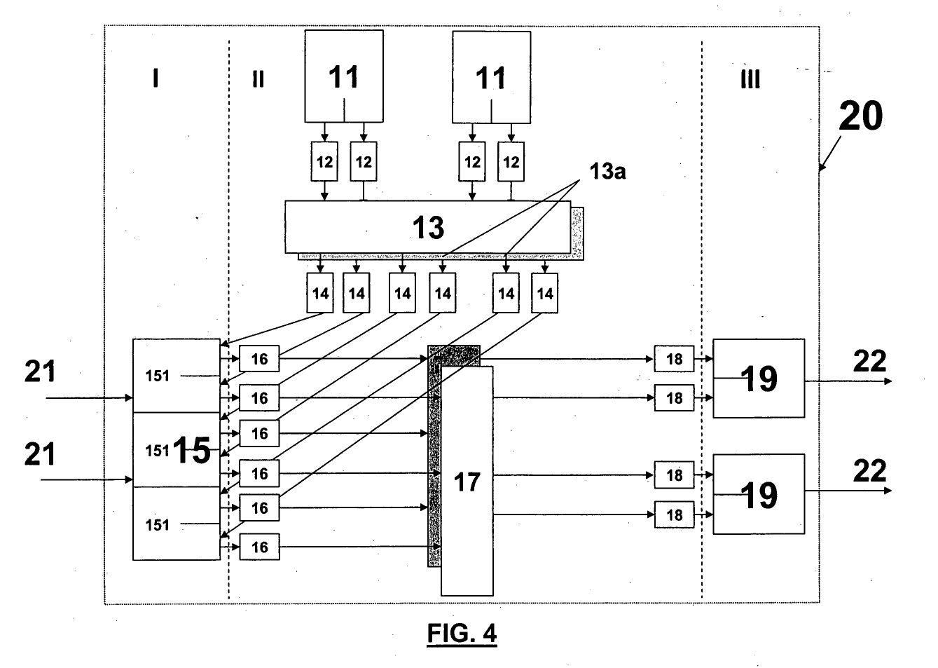

FIG. 4 is a schematic drawing of a self-steering Clos switch 20 in accordance with the invention. Switch 20 appears to resemble the standard square switch, and for purposes of exterior devices interacting therewith it interfaces as a standard square switch. However, switch 20 operates, based on logic within as described below, to route traffic between input and output ports, and in fact in behavior more closely resembles a Clos type switch, despite the square switch-like configuration architecture. Switch 20 can be viewed as a novel form of a time-space-time type switch, in which Stage I, the input stage, is a time component consisting of a memory circuit 15 comprised of smaller memory blocks 151; Stage II, the logic or arbitrator stage, consisting mainly of output arbitrator 17, which is effectively memoryless, is a space component; and Stage III, consisting of another memory 19 comprising the output stage, is again a time component.

The three smaller memories 151 shown in input memory circuit 15 receive incoming traffic from input ports 21. Each of these smaller memories is accessed independently, and consists of a write memory and a read memory, separated by the representative horizontal line in the center of each block in the drawing figure. Incoming data from input ports 21 is written into the write memory and read from the read memory. In this implementation, incoming data is written in 32 bit blocks (4 bytes). The memory 15 contains data for 2 channels (2 bytes per cycle), so one 32 bit word is written on every alternate clock cycle. Each of the smaller memories 151 is therefore written on every 6^{th} clock cycle. Each memory 151 has two ports. One is always available for reading, the other is used to write the incoming data, but may be used as a read port when not required for writes. The configuration and operation of the input memory 15 will be described in greater detail below.

Reading of the read memory portion is conducted under control of read requests from blocks 14. A center stage, output arbitrator 17, conducts switching of the data as it is read from the memory 15. To keep output arbitrator 17 from being overwhelmed by traffic at any particular moment in time, a set of storage memories 16 is provided in the read flow path. These storage memories 16 can be FIFO (first-in-first-out) registers or buffers or the like. Thus data stored in memory 15, and particularly in memory blocks 151, exits same and enters FIFO registers 16. If output arbitrator 17 can handle switching the data at that time, the data is switched to an appropriate output memory 19 as further detailed below. If not, the data is queued in the register 16 until output arbitrator 17 is ready to switch it to the necessary output port. Register 16, in addition to containing the incoming data being switched, includes steering information indicative of which output port 22 it should be switched to.

The switched data is written into an appropriate output memory 19, which, like memory 15, supports multiple ports, in this case two write ports and one read port, as demarcated by a horizontal line in the drawing figure. Additional FIFO registers 18 or the like are provided upstream of output memory 19, for buffering if necessary until output memories 19 become available. Registers 18 may not be necessary in all implementations and may therefore be omitted.

Comparing the behavior of the input memories 15 with that of the output memories 19, it will be appreciated that incoming data from input ports 21 is written into input memories 15 sequentially, but is read out in a non-sequential order determined by the switching decisions of output arbitrator 17. On the other hand, for output memories 19, the data is written in non-sequential order as determined by the switching decisions of output arbitrator 17, but is read out in sequential order on output ports 22.

Configuration memories 11 are provided, serving the role of mapping the operation of switch 20. For every output port 22, configuration memories 11 contain information as to which input port 21 corresponds thereto and from which such input port data should be obtained. Configuration memories 11 thus provide an input/output port definition, whereby each location in a memory 11 corresponds to a particular output port 22, while the content of that location defines a corresponding input port 21. Further, since the switch 20 is a TDM (time division multiplexed) switch, each input/output port definition, or request, obtained from configuration memory 11 also contains information identifying the time slot within the indicated port, for both the input 21 and output 22 ports. Accordingly, the requests from memories 11 are each associated with four pieces of information: input port number, corresponding input port time slot, output port number, and corresponding output port time slot.

Block 13, which designates a circuit effectively operating as an input arbitrator similarly to output arbitrator 17, receives the connection requests from memories 11, possibly by way of FIFO registers or buffers 12 which operate in a similar manner as registers 16, 18, and 14—that is, to hold and queue information or data, in this case the requests, until a downstream stage (input arbitrator 13) can accept it. Since there is a one-to-one mapping of locations in memories 11 to output ports 22, input arbitrator 13 is left with the task of identifying from which input ports 21 and corresponding input memories 15 data should be retrieved for routing to a particular output port 22, and the corresponding input port and output port time slots. Input arbitrator 13 receives routing requests issuing from the memories 11, identifies the relevant input port 21/memory 15, and steers the request to an appropriate FIFO register 14 associated with the identified input port 21/memory 15 so that the request from an appropriate output 13a of input arbitrator 13 will land at the corresponding memory 151 and associated input port 21. For each input memory 151 circuit, the input arbitrator 13 identifies all configuration queues (in FIFO registers 12) that wish to read data therefrom. The input arbitrator 13 then selects one of these, and writes it into the input memory 151 read queue (registers 14). Selection is performed on a normal basis as detailed below. The required traffic byte is read from the input memory 15. When the read port of an input memory circuit 151 is available, connection requests are read from the input memory 151 read read queue (registers 14). The location (input port) of the connection request is used to address the input memory 151 circuit. The byte which is read from the location is appended to the connection request, and written into the input memory 151 output queue (in FIFO registers 16).

It should be noted that there is a one-to-one correspondence of, on the one hand, outputs 13a of input arbitrator 13, and possibly FIFO registers 14, and on the other hand, input ports 21 and memories 151 in input memory 15. Further, the request informs the particular location in memory 15 of the time slot from which data should be obtained. Since at this point the request has arrived at the memory location 15 associated with the correct input port 21, the bit identifying the input port can be stripped off, and after the data from the correct input time slot is obtained, the bit identifying that time slot can also be stripped off.

The data thus obtained is passed to output arbitrator 17, along with the information from the request identifying the output port 22 number and corresponding output port time slot. The data is passed along by the output arbitrator 17 to the FIFO register 18 associated with the appropriate output port 22 and output port time slot. The data is then written into the memory location 19 associated with the destination output port 22, and the remaining pointer information—the output port number and corresponding output port time slot—is then stripped off.

The bandwidth requirement of the portion of the system 20 between the input (15) and output (19) memories—that is, Stage II in FIG. 4—is greater than that of the physical ports 21 and 22. This is because data must be moved in spite of occasional backups which even the FIFOs/buffers may not obviate. Careful construction of the memories can result in a faster transfer of data between the input (15) and output (19) memories. Proper mapping of traffic between the input memory 15 and the output memory 19 can reduce the transit time of this traffic to just over one third of a row in a frame, or 4.7 microseconds.

Circuits 13 and 17, which operate in a similar manner to one another, can both be referred to as arbitrators and serve to guide traffic from a particular input register to a requested output register, and to resolve any occurring contention. The input and output registers in the case of input arbitrator 13 are 12 and 14, respectfully, and in the case of circuits 17 are 16 and 18, respectively. The arbitration in circuits 13 and 17 is preferably conducted on a fair basis. One resolution mechanism can be a round-robin approach, whereby if multiple input FIFO registers are requesting access to a single output FIFO register simultaneously, a round-robin selection is made and access granted in order.

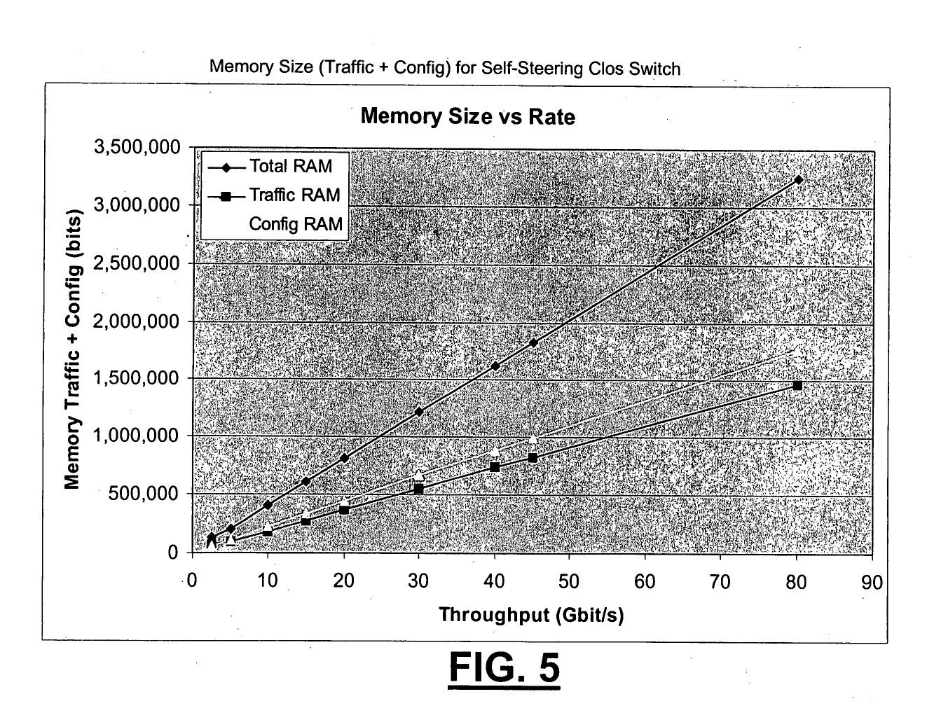

FIG. 5 is a graph showing that the memory requirement of the inventive self-steering Clos switch grows linearly rather than according to the square law, with the growth of data throughput, which is an important advantage of the invention.

It will be appreciated that the implementation depicted in FIG. 4 is a simple case selected for illustrative purposes and depicts a 5 Gbit switch. An extrapolation to a more typical 80 Gbit switch from the 5 Gbit switch shown in FIG. 4 can readily be made by those of ordinary skill in the art. For an 80 Gbit switch, thirty-two input ports 21, memories 11, output ports 22 and memory blocks would be used, along with two arbitrators 13, two arbitrators 17, and sixteen memory blocks 15.

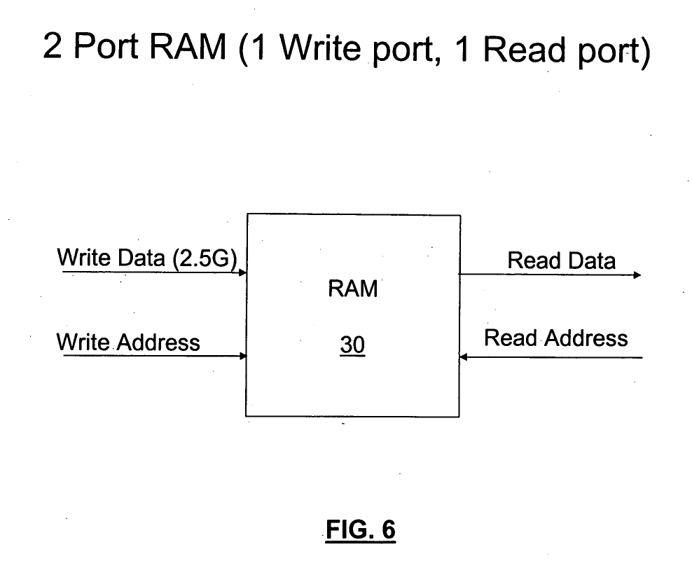

The configuration of the memory 15 for use with the self-steering Clos switch can be more fully explained with reference to FIGS. 6-10. In FIG. 6, a schematic diagram of a conventional two-port RAM 30 is shown, in which the read operation is conducted via the right-hand side port and the write operation is conducted via the left-hand side port. In this conventional case, there is a one-to-one correspondence of read and write ports, and in one characterization the bandwidth available for entering data into the memory is equal to the bandwidth available for extracting it.

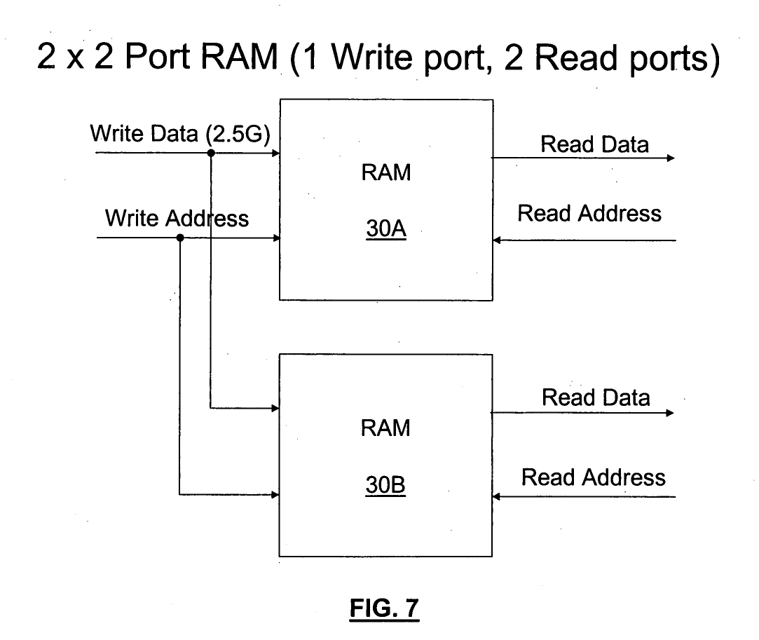

In FIG. 7, two memories, 30A and 30B, which are identical to RAM 30 in FIG. 6, are configured to form a 2×2 port RAM, with one write port and two read ports. In this configuration, the condition that the bandwidth available for traffic leaving the memory system on the right-hand output side is higher than the arrival rate of data entered into the memory system on the left-hand input side is established. This condition enables the establishment of a surplus of available transfer cycles in the middle (Section II) of switch 20 (FIG. 4), allowing arbitrator 17 to suspend its processing routine to allow congestion to clear.

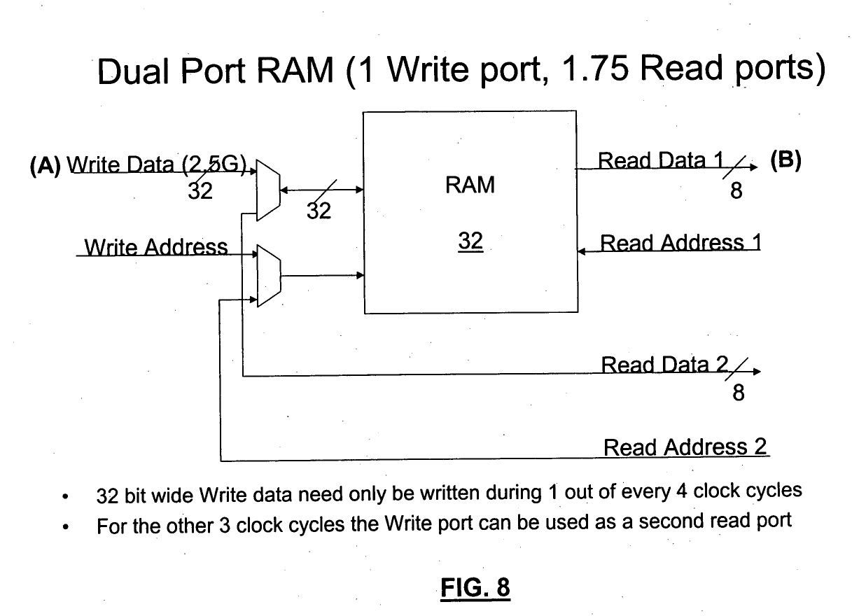

A more efficient approach for achieving a differential in bandwidth between the read and write process capacities occurs by using an input memory configured as shown in FIG. 8. Memory 32 is a dual-port memory, not to be confused with the similarly named two-port memories 30, 30A and 30B of FIGS. 6 and 7. In a dual-port memory, both read and write operations can be performed at each port; in a two-port memory, read operations have a dedicated port, and write operations have a dedicated port.

In the configuration of FIG. 8, rather than write an 8-bit word (byte) in the memory 32 on every clock cycle, a 32 bit (4 byte) word is formed and written into one of the ports (A) on every fourth clock cycle. Read operations can be performed for the other three cycles on that port (A), while the second port (B) is always available for read operations. Normalized mathematically, memory 32 can be described as configured to perform 1 write and 1.75 read operations per cycle. Of course since memory 32 is a dual-port RAM, it should be recognized that the read and write operations can be conducted at either port, or inter-mixed, depending on the application, even though for convenience they are described herein as taking place in port A (one write and three reads) and port B (four reads). It will be appreciated that the write/read ratio of 1:2 per cycle was also achieved in the configuration of FIG. 7, but it required two memory circuits, 30A and 30B.

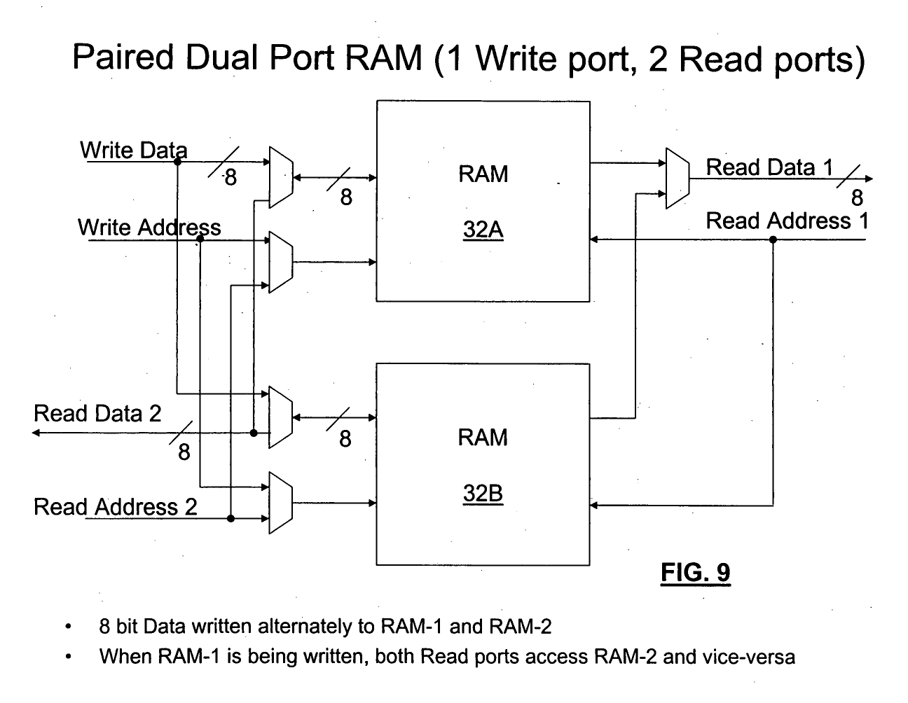

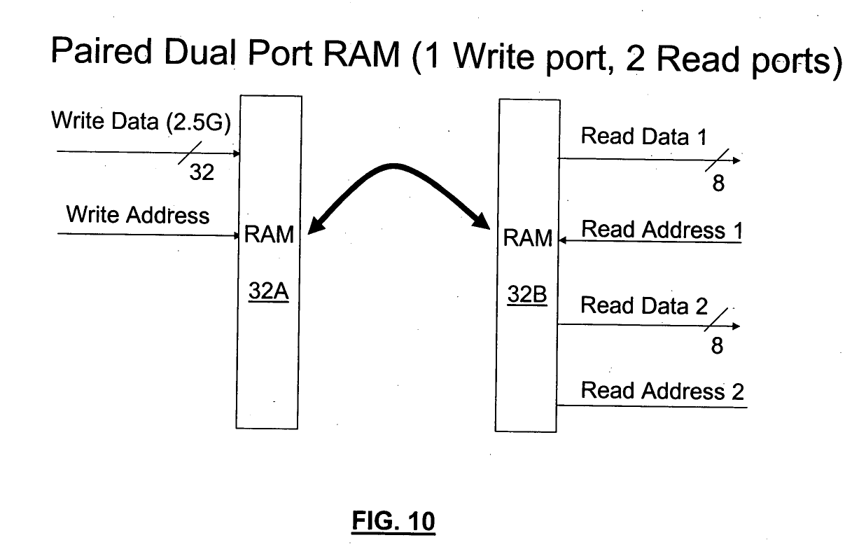

In addition, when using multiple dual-port memories and alternating in time the memory that is being used for the functions of reading and writing, rather than obtaining 1.75 read ports, 2 read ports can be made available. Schematically, this approach is illustrated in FIGS. 9 and 10 and is described with respect to two dual-port RAM memories 32A and 32B similar to RAM 32 of FIG. 8. It allows taking advantage of the fact that at any instant, half the memory is being written (sequentially) and half is being read (randomly—i.e, non-sequentially), with the two physical memory devices 32A, 32B alternating between being written and read. The dual-port read device always has two ports available for read operations. But, instead of having one side of it hard-wired to the write traffic, and the other side wired to the read traffic, every time a 125 micro second boundary (or other boundary in time) is reached, the contents between the two memories are flipped. In this manner, functions are switched and at any one instance one memory is being used entirely for write operations, and the other memory is being used entirely for read operations. Because the memories 32A, 32B are dual-port memories, this effectively allows two simultaneous read operations in the memory being used for reading. The switching operation may be viewed as using two pages of memory, one of which is written linearly while the other read randomly (that is, non-sequentially). One page can be assigned into each memory. After filling a page with writes, the pages are swapped so that this data can be read. This can take place at regular intervals, for example every 125 μsec. At any time, all write operations are directed to one RAM, and both ports of the other RAM are therefore free for read operations. One disadvantage of this approach is that the there is a spare read port on the RAM which is being written to, but without simultaneous read and write of the same page, this spare port cannot be made use of. A more efficient implementation, which makes use of all ports at all times, is described in the preferred embodiment below.

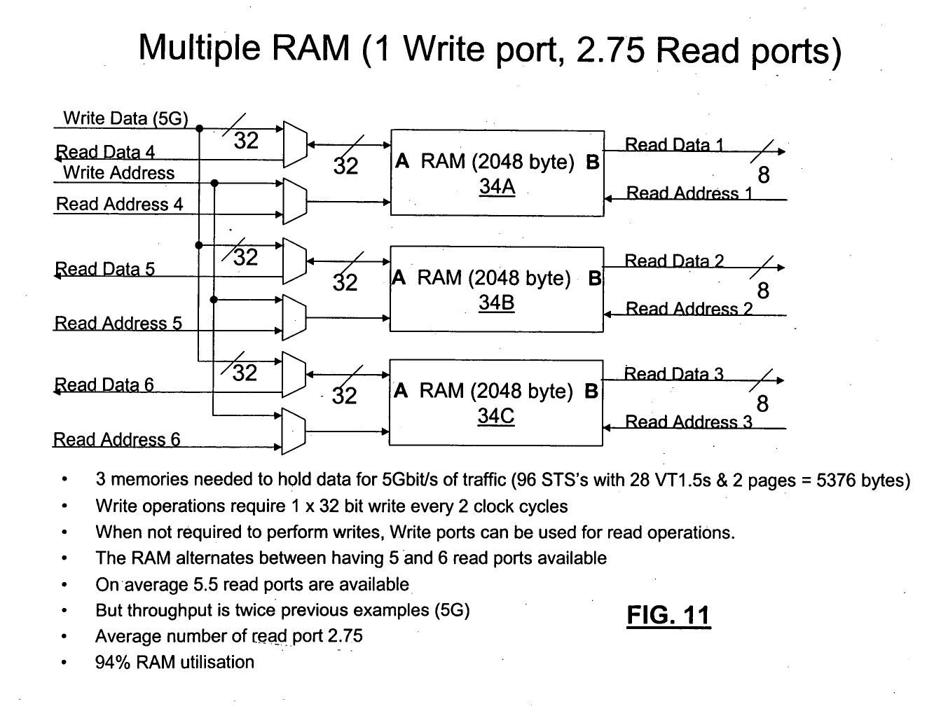

In accordance with the preferred embodiment of the invention described with reference to FIG. 11, three dual-port memory devices 34A-34C, each consisting of a 2048-byte RAM which is similar to and operated in a similar manner to memory 32 as described with reference to FIGS. 8 and 9 above, are arranged such that one write operation is performed into each of memories 34A-34C every six cycles. As a group, the three memories are written into once every two clock cycles. The data being input is 32 bits wide. This equates to 10 Gbits of traffic with a system clock of 311 MHz. When a memory is not being used for write operations it is available for reading. Therefore, over six clock cycles, each port on the input side (left-hand) is available for reading during five of those six cycles. On the output (left-hand) side, each of the ports is available for reading six out of the six cycles. For this embodiment, ingress is 5 Gbit/s=32 bits at 155 MWords/s (or 1 word every 2 cycles at 311 MHz). The RAM requirement is 64 bytes per STS×96 STSs (5G)=6144 bytes=3×2048 bytes. The RAMS are three dual-port devices (31-33). For the A port, it is shared between ingress (sequential) writes, and switch (random) reads. Writes are 32 bits wide, and one occurs on every 6th cycle to each of RAMS 34A-34C. At all other times the RAMS 34A-34C are available to be read. Reads are 8 bits wide. Three A ports are available. For the B port, it is available to be read at all times, with reads being 8 bits wide. Three B ports are available. Write bandwidth is 5G (STS-96). Read bandwidth is 13.75G (STS-264). This solution supports 100% 1-2 bridging and 91% 1-3 bridging.

The arrangement of FIG. 11 effectively adds five and a half ports available for the read operation, enabling 5G traffic capacity. So, in terms of the previous examples the throughput of this really equates to 5.5 read ports. Basically, it will have to be read twice as often. It effectively operates 2.75 read ports when its shared across twice as much bandwidth. In addition, the total memory needed to for the switching operation effectively uses 94% of the RAM space shown, providing a large amount of bandwidth extension. The embodiment of FIG. 11 thus frees up more time slots available in the core (Stage II) for switching the traffic, and makes efficient use of input memories used in Stage I. Importantly, by providing an excess of read bandwidth over write bandwidth, the input stage comprised of memory 15 provides a time buffer which enables the arbitration stage to resolve congestion without blockage. The inventive self-steering switch can thus be characterized as non-blocking, but realizes this desirable advantage using a much lower memory requirement than a conventional square switch.

The above are exemplary modes of carrying out the invention and are not intended to be limiting. It will be apparent to those of ordinary skill in the art that modifications thereto can be made without departure from the spirit and scope of the invention as set forth in the following claims.

1. A self-steering switch comprising:
an input stage;
an arbitration stage; and
an output stage,
the switch being configured such that the input stage accumulates a surplus of switching cycles to thereby enable the arbitration stage to suspend transfer of data without disrupting data traffic flow between the input stage and the output stage.

2. A self-steering switch comprising:
an input stage;
an arbitration stage; and
an output stage,
the input stage comprising a memory block of one or more dual-port memory devices into which data is written during one or more write operations and is read during one or more read operations, the memory block being configured such that, for a repeating time duration containing a predefined number of clock cycles, the number of read operations from the memory block exceeds the number of write operations to the memory block.

3. The switch of claim 2, wherein the memory block contains three dual-port RAMs (random access memories) having 6 ports, 3 of which are available six out of every six cycles, and 3 of which are available five out of every six cycles.

4. The switch of claim 2, wherein data is written into the memory block in 32-bit words and is read from the memory block in 8-bit words.

5. The switch of claim 2, wherein data is written into the memory block sequential and is read from the memory block non-sequentially.

6. A self-steering switch for directing data traffic between one or more input ports and one or more output ports, the switch comprising:
an input stage into which data is sequentially written;
an arbitration stage which causes non-sequential reading of the data written into the input stage; and
an output stage into which the arbitration stage causes the non-sequentially read data to be written, and from which said data is sequentially read,
wherein the input stage is configured to have an excess of read bandwidth over write bandwidth, said excess being utilized by the arbitration stage to resolve traffic congestion without blockage.

7. The switch of claim 6, wherein the arbitration stage includes a configuration memory, first and second arbitrators, and one or more buffers.

8. The switch of claim 7, wherein the configuration memory provides an input/output port definition.

9. The switch of claim 8, wherein each location of the configuration memory corresponds to a particular output port and contains information identifying an associated input port.

10. The switch of claim 9, wherein the switch is time division multiplexed, each memory location in the configuration memory further including read and write time slot information for each input and/or output port associated with that memory location.

11. The switch of claim 7, wherein non-sequential reading of data from the input stage is at the direction of the first arbitrator, which resolves contention for read locations on a fair basis.

12. The switch of claim 11, wherein the fair basis involves a round-robin scheme.

13. The switch of claim 7, wherein writing of data from into the output stage is at the direction of the second arbitrator, which resolves contention for write locations on a fair basis.

14. The switch of claim 13, wherein the fair basis involves a round-robin scheme.

15. A method for directing data traffic flow between one or more input ports and one or more output ports, the method comprising:
writing data sequentially into an input stage;
reading the data non-sequentially from the input stage, wherein said writing and reading of data from the input stage cause an excess of read bandwidth over write bandwidth;
writing the non-sequentially read data into the output stage; and
utilizing said excess of read bandwidth to resolve traffic congestion between the input and output ports without blockage.

16. The method of claim 16, further comprising arbitrating data access contention on a fair basis.

17. The method of claim 17, wherein said arbitrating is conducted using a round-robin scheme.

18. A method for directing data traffic flow between one or more input ports and one or more output ports, the method comprising:
writing data into an input stage;
reading the data from the input stage, wherein, for a repeating time duration containing a predefined number of clock cycles, said reading is performed more than said writing; and
writing the data read from the input stage into an output stage.

19. The switch of claim 18, wherein data is written into the memory block sequential and is read from the memory block non-sequentially.

20. A method for directing data traffic flow between one or more input ports and one or more output ports using an arbitration stage, the method comprising:
writing data into an input stage;
reading the data from the input stage;
writing the data read from the input stage into an output stage; and
accumulating a surplus of switching cycles to thereby enable the arbitration stage to suspend transfer of data without disrupting data traffic flow between the input stage and the output stage.
